(19) United States
(12) Patent Application Publication
(10) Pub. No.: US 2021/0207344 A1
(43) Pub. Date: Jul. 8, 2021

(54) HYDRAULIC SYSTEM FOR INCREASING OPERATION SPEED OF CONSTRUCTION MACHINERY BOOM

(71) Applicant: Doosan Infracore Co., Ltd., Incheon (KR)

(72) Inventor: Byung Il KANG, Incheon (KR)

(21) Appl. No.: 16/755,841

(22) PCT Filed: Oct. 11, 2018
(86) PCT No.: PCT/KR2018/011977

§ 371 Date: Apr. 13, 2020

(30) Foreign Application Priority Data
Oct. 13, 2017 (KR) 10-2017-0132930

(51) Int. Cl. E02F 9/22; E02F 9/20; F15B 11/024

(52) U.S. Cl. CPC E02F 9/2217; E02F 9/2271; E02F 9/2267; E02F 9/2228; E02F 9/2004; F15B 2211/5159; E02F 9/2296; E02F 9/2285; E02F 9/2292; F15B 2211/3058; F15B 11/024

(57) ABSTRACT

A hydraulic system for increasing a speed of a boom of a construction machine includes a boom cylinder configured to operate the boom of the construction machine; a main control valve including a boom control spool that is configured to selectively supply a hydraulic oil from a hydraulic pump to a boom head chamber and a boom rod chamber of the boom cylinder; a regeneration device connected to the boom head chamber of the boom cylinder through a hydraulic regeneration line and configured to regenerate an energy of the boom cylinder; and a regeneration valve unit provided at the hydraulic regeneration line and including a flow control valve configured to control a flow rate of a hydraulic oil flowing through the hydraulic regeneration line. An energy stored in the regeneration device is directly supplied to the boom cylinder through the flow control valve when the boom ascends.

### TECHNICAL FIELD

The present disclosure relates to a hydraulic system for increasing an operation speed of a boom of a construction machine. More specifically, the present disclosure relates to a hydraulic system for increasing an operation speed of a boom of a construction machine to control a boom cylinder that raises and lowers the boom of the construction machine.

### DISCUSSION OF RELATED ART

A construction machine such as excavators may use a hydraulic cylinder to raise and lower a front work device. For example, by operating a hydraulic pump using an engine power, a hydraulic oil discharged from the hydraulic pump may flow into a boom cylinder via a main control valve and a boom may ascend while a stroke of the boom occurs. Meanwhile, when the boom descends, the hydraulic oil may be discharged from the boom cylinder to a drain tank via the main control valve by the weight of the front work device. In such a boom descending operation, since a potential energy of the front work device is not effectively utilized and dissipated, a technique for recovering and recycling such a potential energy in an appropriate manner has been developed.

### Technical Objectives

Embodiments of the present disclosure provides a hydraulic system for increasing an operation speed of a boom of a construction machine that includes a boom energy regeneration device capable of greatly improving a work amount by greatly increasing a boom ascending speed of a construction machine.

### Technical Solution to the Problem

According to embodiments, a hydraulic system for increasing a speed of a boom of a construction machine includes a boom cylinder configured to operate the boom of the construction machine; a main control valve including a boom control spool that is configured to selectively supply a hydraulic oil from a hydraulic pump to a boom head chamber and a boom rod chamber of the boom cylinder through a boom head hydraulic line and a boom rod hydraulic line, respectively; a regeneration device connected to the boom head chamber of the boom cylinder through a hydraulic regeneration line and configured to regenerate an energy of the boom cylinder; and a regeneration valve unit provided at the hydraulic regeneration line and including a flow control valve configured to control a flow rate of a hydraulic oil flowing through the hydraulic regeneration line. An energy stored in the regeneration device is directly supplied to the boom cylinder through the flow control valve when the boom ascends.

According to embodiments, when the boom ascends, the flow control valve of the regeneration valve unit may control a flow rate supplied from the regeneration device to the boom cylinder in proportion to a manipulation amount of a manipulation unit.

According to embodiments, the regeneration valve unit may further include an open-close valve provided at a connection line that connects the hydraulic regeneration line and the boom rod chamber, the open-close valve configured to selectively supply part of the hydraulic oil discharged through the hydraulic regeneration line to the boom rod chamber of the boom cylinder.

According to embodiments, the open-close valve may be closed when the boom ascends.

According to embodiments, the regeneration device may include a hydraulic motor connected to the hydraulic regeneration line, and the hydraulic motor may be connected to a drive shaft of an engine and provides a rotational force to the hydraulic pump when the boom descends.

According to embodiments, when the boom ascends, the hydraulic motor may be controlled so that a torque for engine assistance is not generated.

According to embodiments, in the hydraulic motor, a swash plate angle may be controlled to be neutral so that a torque for engine assistance is not generated.

According to embodiments, the regeneration device may include an accumulator connected to the hydraulic regeneration line, and a flow rate of a head side of the boom cylinder at a high pressure, which is pressurized when the boom descends, may be stored in the accumulator through the hydraulic regeneration line, thereby regenerating an energy of the boom cylinder.

According to embodiments, the hydraulic system may further include a first regeneration open-close valve provided between the accumulator and the hydraulic regeneration line. When the boom descends, the first regeneration open-close valve may be opened so that a high-pressure hydraulic oil pressurized by a potential energy of the boom is accumulated, and when the boom ascends, the first regeneration open-close valve may supply the accumulated hydraulic oil to the hydraulic motor to assist the engine.

According to embodiments, the hydraulic system may further include a second regeneration open-close valve provided between downstream of the first regeneration open-close valve and a tank, the second regeneration open-close valve opened to discharge the hydraulic oil accumulated in the accumulator to the tank when the engine is stopped.

According to embodiments, the hydraulic system may further include a control unit configured to control the main control valve, the regeneration device, and the regeneration valve unit according to a manipulation signal transmitted by a manipulation unit.

According to embodiments, the control unit may control the flow control valve in proportion to a boom speed increase signal manipulated by the manipulation unit, so that when the boom ascends, a hydraulic oil is supplied, in proportion to the boom speed increase signal, directly to the boom cylinder through the flow control valve.

### Effects of the Invention

A hydraulic system for increasing an operation speed of a boom of a construction machine according to embodiments of the present disclosure may greatly improve a work amount by increasing a boom ascending speed during works where a boom cylinder speed is important, such as excavation loading works.

However, the effects of embodiments of the present disclosure are not limited to the above-mentioned effects and may be variously extended without departing from the spirit and scope of the present disclosure.

### BRIEF DESCRIPTION OF THE DRAWINGS

FIG. 1 is a side view illustrating a basic structure of a conventional construction machine.

FIG. 2 is a hydraulic circuit diagram illustrating a hydraulic system of a construction machine including a regeneration device for recovering an energy when a boom descends.

FIGS. 3 and 4 are hydraulic circuit diagrams in the hydraulic system of FIG. 2 when the boom descends.

FIG. 5 is a hydraulic circuit diagram in the hydraulic system of FIG. 2 when the boom ascends.

FIG. 6 is a hydraulic circuit diagram illustrating a hydraulic system for increasing a speed of a boom of a construction machine according to embodiments of the present disclosure.

FIG. 7 is a hydraulic circuit diagram illustrating a hydraulic system for increasing a speed of a boom of a construction machine according to an embodiment of the present disclosure.

### DESCRIPTION OF MAIN REFERENCE NUMERALS OF DRAWINGS

10: construction machine

20: lower traveling body

30: upper swing body

32: upper frame

50: cab

52: manipulation unit

60: front work device

70: boom

72: boom cylinder

72a: boom head chamber

72b: boom rod chamber

80: arm

82: arm cylinder

90: bucket

92: bucket cylinder

100: engine

200: hydraulic pump

201: hydraulic motor

210: hydraulic line

212: return hydraulic line

220: high-pressure hydraulic line

222: boom head hydraulic line

224: boom rod hydraulic line

230: hydraulic regeneration line

300: main control valve

310: boom control spool

400: regeneration valve unit

410: discharge control valve

420: flow control valve

430: open-close valve

500: accumulator

510: regeneration open-close valve unit

511: first generation open-close valve

512: second regeneration open-close valve

600: control unit

### DETAILED DESCRIPTION

In respect to embodiments of the present disclosure disclosed herein, specific structural or functional descriptions are merely exemplified for illustrative purposes only, and embodiments of the present disclosure may be implemented in various form and should not be construed as being limited to embodiments described herein.

When an element is described as “being connected to” or “contacting” another element, it is to be understood not only that the element may be directly connected to or contact another element, but also that an additional element may exist therebetween. On the other hand, when an element is described as “being directly connected to” or “directly contacting” another element, it is to be understood that an additional element does not exist therebetween. Other expressions describing the relationship between elements, such as “between” and “directly between” or “neighboring to” and “directly neighboring to” should be construed as well.

The terms used herein are only used to describe specific embodiments and are not intended to limit the inventive step of the present disclosure. Singular expressions include plural expressions, unless the context clearly indicates otherwise. As used herein, it should be understood that the terms “include” or “have” are intended to indicate that feature, number, step, action, element, part, or combination thereof is present, and it does not preclude the presence of or possibilities of adding one or more features, numbers, steps, actions, elements, parts, or combination thereof.

Hereinafter, embodiments of the present disclosure will be described in detail with reference to the accompanying drawings. The same reference numerals are used for the same elements in the drawings, and duplicate descriptions for the same elements are omitted.

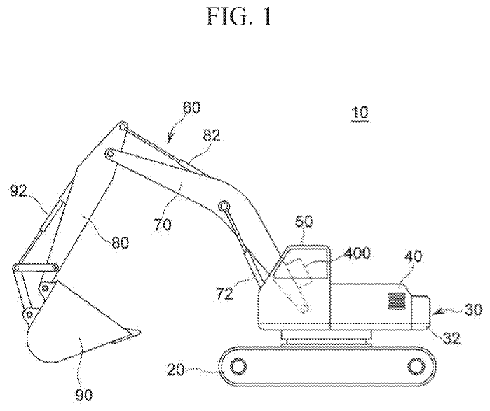

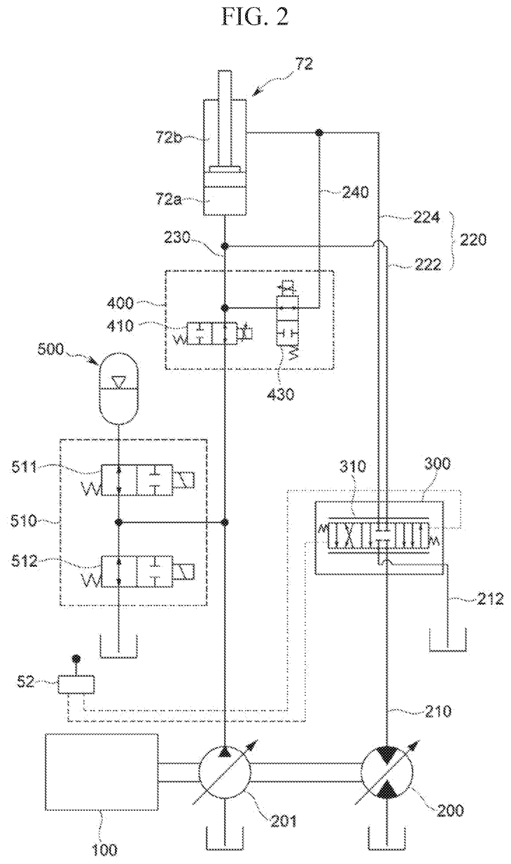

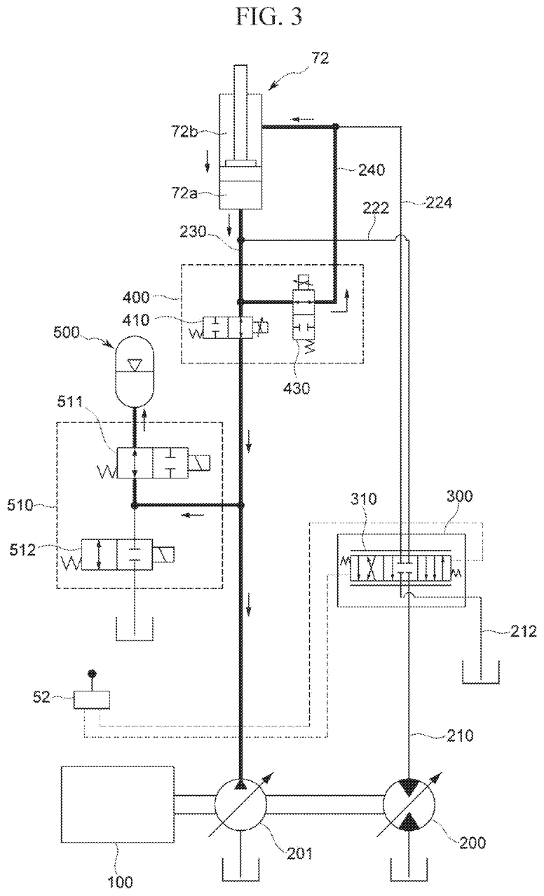

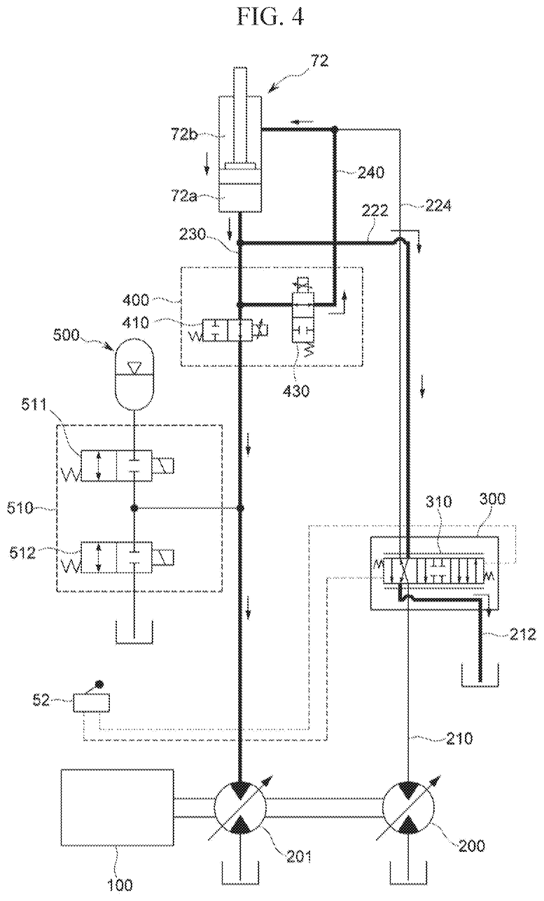

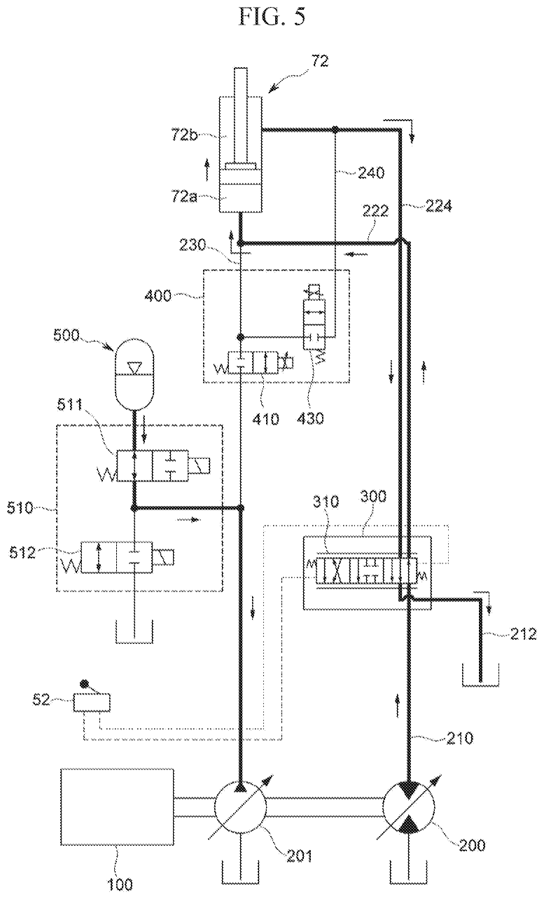

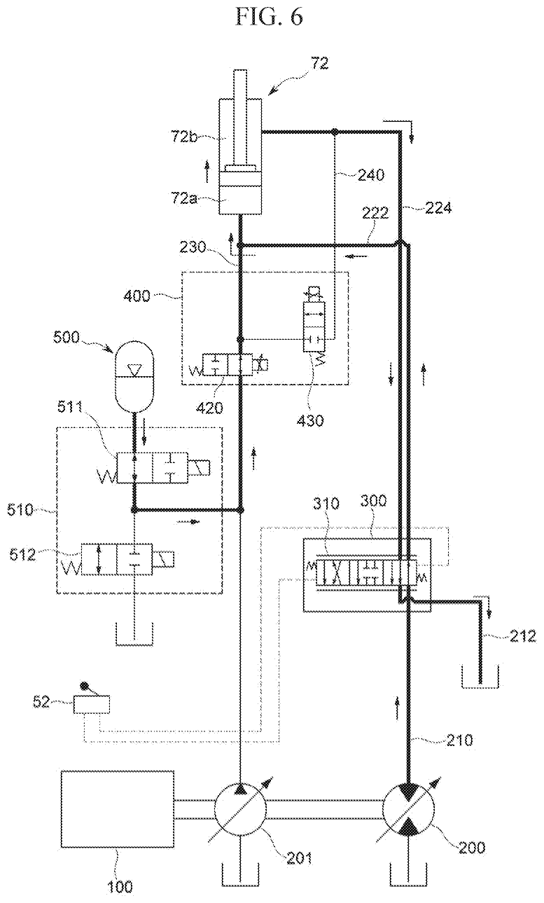

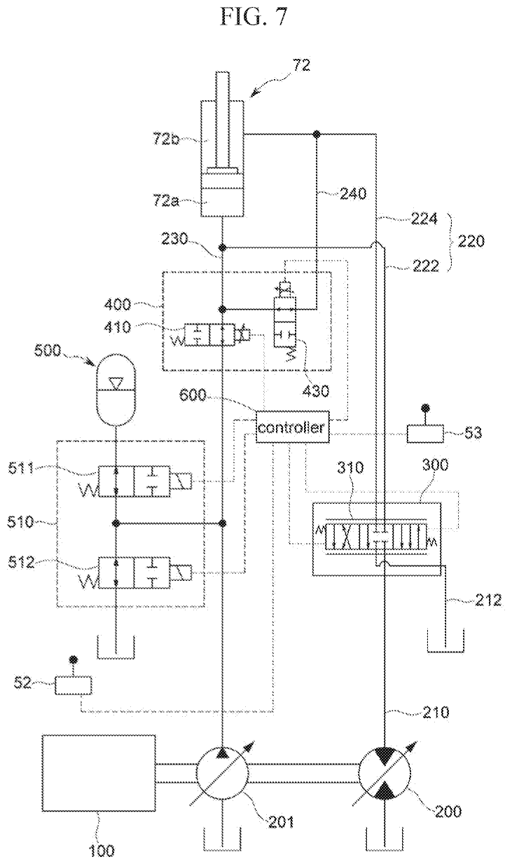

FIG. 1 is a side view illustrating a basic structure of a conventional construction machine. FIG. 2 is a hydraulic circuit diagram illustrating a hydraulic system of a construction machine including a regeneration device for recovering an energy when a boom descends. FIGS. 3 and 4 are hydraulic circuit diagrams in the hydraulic system of FIG. 2 when the boom descends. FIG. 5 is a hydraulic circuit diagram in the hydraulic system of FIG. 2 when the boom ascends. FIG. 6 is a hydraulic circuit diagram illustrating a hydraulic system for increasing a speed of a boom of a construction machine according to embodiments of the present disclosure. FIG. 7 is a hydraulic circuit diagram illustrating a hydraulic system for increasing a speed of a boom of a construction machine according to an embodiment of the present disclosure.

Referring to FIG. 1, a construction machine 10 includes a lower traveling body 20, an upper swing body 30 swingably mounted on the lower traveling body 20, and a cab 50 and a front work device 60 provided at the upper swing body 30.

The lower traveling body 20 may support the upper swing body 30 and may enable the construction machine 10 to travel by using a power generated by an engine 100 (see FIG. 2). The lower traveling body 20 may be a caterpillar-type traveling body that includes a caterpillar, as illustrated in FIG. 1. Alternatively, the lower traveling body 20 may be a wheel-type traveling body that includes traveling wheels. The upper swing body 30 may include an upper frame 32 as a base, and may rotate on the lower traveling body 20, on a plane parallel to the ground, thus setting a working direction. The cab 50 may be provided on the left front side of the upper frame 32, and the front work device 60 may be mounted on the front side of the upper frame 32.

The front work device 60 may include a boom 70, an arm 80 and a bucket 90. A boom cylinder 72 for controlling movement of the boom 70 may be provided between the boom 70 and the upper frame 32. An arm cylinder 82 for controlling movement of the arm 80 may be provided between the boom 70 and the arm 80. In addition, a bucket cylinder 92 for controlling movement of the bucket 90 may be provided between the arm 80 and the bucket 90. As the boom cylinder 72, the arm cylinder 82, and the bucket cylinder 92 are extended or contracted, the boom 70, the arm 80, and the bucket 90 may implement various movements, and the front work device 60 may perform various works. In such a case, the boom cylinder 72, the arm cylinder 82 and the bucket cylinder 92 may be extended or contracted by a hydraulic oil supplied from the hydraulic pump 200 (see FIGS. 2 to 5).

In an embodiment, an energy regeneration system for regenerating a boom energy that may be generated from the boom cylinder 72 when the boom 70 descends may be provided. A regeneration valve unit 400 including a plurality of valves may constitute part of the energy regeneration system.

Such an energy regeneration system, as described below, may accumulate a high-pressure hydraulic oil that is discharged from the boom cylinder 72 when the boom 70 descends or may rotate a hydraulic motor 201, thereby assisting output of an engine.

As illustrated in FIG. 2, a hydraulic system of a construction machine according to embodiments may include at least one hydraulic pump 200 connected to an engine 100, at least one actuator 72, 82, 92 for operating the front work device, a main control valve (MCV) 300 provided at a flow path between the hydraulic pump and the actuator and controlling operation of the actuator, and a regeneration device for regenerating energy of the front work device.

In embodiments, the engine 100 may include a diesel engine as a driving source of a construction machine such as an excavator. At least one hydraulic pump 200 may be connected to the engine 100 through a power take-off (PTO) (not illustrated). Although not illustrated in the drawings, a pilot pump and additional hydraulic pumps may be connected to the engine 100. Accordingly, a power from the engine 100 may be transmitted to the hydraulic pump 200 and the pilot pump.

The hydraulic pump 200 may be connected to the main control valve 300 through a hydraulic line 210. The main control valve 300 may receive a hydraulic oil from the hydraulic pump 200 through the hydraulic line 210 and may supply it to the actuator such as the boom cylinder 72, the arm cylinder 82, the bucket cylinder 92, and the like.

The main control valve 300 may be connected to each of a plurality of actuators, including the boom cylinder 72, the arm cylinder 82, and the bucket cylinder 92, through a high-pressure hydraulic line 220. Accordingly, each of the actuators such as the boom cylinder, the arm cylinder, and the bucket cylinder may be driven by the hydraulic pressure of the hydraulic oil discharged from the hydraulic pump 200.

For example, a boom control spool 310 in the main control valve 300 may be connected to a boom head chamber 72a and a boom rod chamber 72b of the boom cylinder 72 through a boom head hydraulic line 222 and a boom rod hydraulic line 224, respectively. Accordingly, the boom control spool 310 may be switched to selectively supply the hydraulic oil discharged from the hydraulic pump 200 to the boom head chamber 72a and the boom rod chamber 72b.

The hydraulic oil driving the actuator may be returned to a drain tank T through a return hydraulic line 212. In embodiments, when the boom descends, a hydraulic oil from the boom head chamber 72a may be discharged to the drain tank T via the boom control spool 310 through the boom head hydraulic line 222 (see FIGS. 3 and 4). In addition, when the boom ascends, a hydraulic oil from the boom rod chamber 72b may be discharged to the drain tank T via the boom control spool 310 through the boom rod hydraulic line 224 (see FIG. 5).

In embodiments, the hydraulic system of the construction machine may include a regeneration valve unit 400 that is provided at a hydraulic regeneration line 230 connected to the boom head chamber 72a to control supply of the hydraulic oil to the regeneration device. The regeneration valve unit 400 may include a discharge control valve 410 and an open-close valve 430, but embodiments are not limited thereto, and the regeneration valve unit 400 may include various valves suitable for the energy regeneration system.

The hydraulic regeneration line 230 may be connected to the boom head chamber 72a. A hydraulic line from the boom head chamber 72a may branch into the boom head hydraulic line 222 and the hydraulic regeneration line 230. The discharge control valve 410 is provided at the hydraulic regeneration line 230 and controls a flow rate of a hydraulic oil flowing through the hydraulic regeneration line 230. The open-close valve 430 is provided at a connection line 240 that connects the hydraulic regeneration line 230 and the boom rod chamber 72b, and is controlled so that part of the hydraulic oil discharged through the hydraulic regeneration line 230 may be selectively supplied to the boom rod chamber 72b of the boom cylinder 72.

As illustrated in FIG. 7, in embodiments, a control unit 600 which outputs, according to a selected control mode, a pilot signal pressure to the regeneration valve unit to control supply of the hydraulic oil to the regeneration device through the hydraulic regeneration line 230 may be further provided. Such a control unit 600 may be applied to and implemented in other embodiments disclosed in the present disclosure.

The pilot signal pressure may be supplied to the discharge control valve 410 to open the hydraulic regeneration line 230. The discharge control valve 410 may have a variable opening area, through which the flow passes, depending on a position of the control spool. Accordingly, the discharge control valve 410 may control an open-close operation and a flow rate of the hydraulic regeneration line 230.

In addition, the pilot signal pressure may be supplied to the open-close valve 430 to open the connection line 240. Accordingly, the boom rod chamber 72b may be connected to the hydraulic regeneration line 230 through the connection line 240, thereby capable of supplying, to the boom rod chamber 72b of the boom cylinder 72, an insufficient flow rate that may be caused due to an area difference between a head side and a rod side of the boom cylinder 72 when the boom descends.

In embodiments, the regeneration device may regenerate energy by using a high-pressure hydraulic oil discharged from the boom head chamber 72a of the boom cylinder 72 when the boom 70 descends. The regeneration device may include an accumulator 500 and a hydraulic motor 201. One end of the hydraulic regeneration line 230 may branch to be connected to the accumulator 500 and the hydraulic motor 201, respectively.

The accumulator 500 may store the high-pressure hydraulic oil discharged from the boom head chamber 72a of the boom cylinder 72 when the boom descends. A regeneration open-close valve unit 510 including a first generation open-close valve 511 and a second regeneration open-close valve 512 is provided at the hydraulic regeneration line 230 connected to the accumulator 500, thus capable of controlling supply/discharge of the hydraulic oil from the accumulator 500. More specifically, the first regeneration open-close valve 511 may be provided between the hydraulic regeneration line 230 and the accumulator 500, and the second regeneration open-close valve 512 may be provided between downstream of the first regeneration open-close valve 511 and a tank. In a case where the energy is regenerated using the high-pressure hydraulic oil when the boom descends, the first regeneration open-close valve 511 is opened, and in a case where an energy is not regenerated, the first regeneration open-close valve 511 is closed. The second regeneration open-close valve 512 serves to discharge the high-pressure hydraulic oil that is stored in the accumulator 500 to the tank for safety when the engine is stopped, and always maintains a closed state while the hydraulic system of the present disclosure is operated. When the hydraulic system is not operated for a long period of time after operation is completed, the high-pressure hydraulic oil charged in the accumulator 500 may cause a safety problem, and thus the first regeneration open-close valve 511 and the second regeneration open-close valve 512 are opened so that the flow from the accumulator 500 is automatically discharged to the tank.

The hydraulic motor 201 may be connected to a drive shaft of the engine 100 and assist an engine output to provide a rotational force to the hydraulic pump. The hydraulic motor 201 may be connected to the drive shaft of the engine 100 through a power transmission device (PTO) (not illustrated) having a constant gear ratio.

In embodiments, the main control valve 300 may include a hydraulic control valve. The boom control spool 310 may be controlled by a pilot pressure proportional to a manipulation amount of a manipulation unit 52. In addition, a manipulation signal based on the manipulation of the manipulation unit 52 is transmitted to the control unit 600, and the control unit 600 may control a swash plate angle of the boom control spool 310, the discharge control valve 410, the flow control valve 420, the first regeneration open-close valve 511, the second regeneration open-close valve 512, and the hydraulic motor 201. In addition, in the related drawings, the control unit 600, although not illustrated, may control valves and spools, or the valves and spools may be directly controlled by the manipulation unit 52 according to the user's selection.

In detail, as illustrated in FIG. 3, when a control mode selected by an operator is a boom descending mode and the operator inputs a boom descending signal through the manipulation unit 52, a pilot signal pressure in the boom descending mode is applied to the discharge control valve 410 and the open-close valve 430 to open the hydraulic regeneration line 230. Accordingly, a pressure of a head side of the boom cylinder, which is a high pressure, is transmitted to a rod side of the boom cylinder, and thus the pressure of the head side of the boom cylinder becomes higher than a normal excavator pressure. A pressurized flow rate of the head side of the boom cylinder at a high pressure is stored in the accumulator 500 through the hydraulic regeneration line 230 via the discharge control valve 410, thus recovering a potential energy of the boom, and part of the flow rate assists an engine torque while passing through the hydraulic motor 201. In an embodiment, if a pressure of the accumulator 500 is high that a boom descending flow rate may not be stored, the boom descending flow rate may be discharged through the main control valve 300, as illustrated in FIG. 4, or although not illustrated in the drawings, may be discharged through an additionally installed valve.

As illustrated in FIG. 5, when a boom ascending signal is input by an operator and it is a boom ascending mode, the boom cylinder receives the flow rate from the hydraulic pump 200 and the discharge control valve 410 and the open-close valve 430 in the regeneration valve unit 400 are all closed. In such a case, the high-pressure hydraulic oil stored in the accumulator 500 is supplied to the hydraulic motor 201 to assist the engine.

FIG. 6 is a hydraulic circuit diagram illustrating a hydraulic system for increasing a speed of a boom of a construction machine according to embodiments of the present disclosure. In the hydraulic system of FIG. 6, a flow control valve 420 that variably controls the flow rate, such as the discharge control valve 410 in the regeneration valve unit 400 in FIGS. 2 to 5, is provided in the regeneration valve unit 400.

In the hydraulic system of FIG. 6, when the boom ascends, the flow control valve 420 is opened and an energy stored in the accumulator 500 is directly supplied to the boom cylinder 72 through the flow control valve 420. When the boom ascends, the flow control valve 420 of the regeneration valve unit 400 is controlled by the control unit 600 in proportion to the manipulation amount of the manipulation unit 52, while the flow rate supplied from the accumulator 500 to the boom cylinder 72 is controlled, and the open-close valve 430 is closed. In such a case, the hydraulic motor 201 is controlled not to generate torque for engine assistance.

That is, the hydraulic system of FIG. 6 is provided with a boom-speed increase function in the manipulation unit 52, such as a joystick, or other device, and when the boom ascends, a driver activates the boom-speed increase function to increase the boom speed. When the boom-speed increase function is activated, the first regeneration open-close valve 511 of the accumulator 500 is opened by the control unit 600, the flow control valve 420 is also opened, and the hydraulic motor 201 is controlled so that the swash plate angle is in a neutral position and torque is not generated. Accordingly, the boom ascending speed is increased by additionally supplying the flow rate from the accumulator 500 in addition to the flow rate from the hydraulic pump 200.

The above will be described below in more detail. In general, when the boom descends, a head pressure of the boom is about 110 bar, and when it is stored in the accumulator, a maximum pressure of the accumulator may not exceed 110 bar. Meanwhile, when the boom ascends, the head pressure of the boom is required to be 110 bar or more, and accordingly, in a case where the potential energy of the boom is stored in the accumulator, without a separate device, a pressure stored in the accumulator is lower than the head pressure of the boom that is required when the boom ascends, and thus the flow rate may not be directly supplied to the head side of the boom. However, in the hydraulic system of the present disclosure, when the boom descends, the head pressure of the boom is supplied to the rod side, thereby increasing a rod pressure of the boom, and the increased rod pressure of the boom may pressurize the head side of the boom again to make the head pressure of the boom 200 bar or more, and an accumulator pressure may also be stored up to 200 bar or more. In such case, since the accumulator pressure is higher than the head pressure of the boom when the boom ascends, the flow rate of the accumulator may be directly supplied to the head side of the boom, thereby increasing the ascending speed of the boom.

With manipulation in the above-described manner, the ascending speed of the boom may be greatly increased, and accordingly, a work amount may be greatly increased during works where a boom cylinder speed is important, such as an excavation loading work.

In an embodiment, when the boom descends, the flow control valve 420 of FIG. 6 performs the same function as the discharge control valve 410 of FIGS. 2 to 5. Although not illustrated in the drawings, when the boom descends, torque for engine assistance may be generated by using part of the flow rate of the boom head chamber. If an engine load is very small, the swash plate angle of the hydraulic motor 201 may be reduced to increase the flow rate accumulated in the accumulator 500.

Although the above is described with reference to embodiments of the present disclosure, it is to be understood that those skilled in the art may variously modify and change the present disclosure without departing from the spirit and scope of the inventive step described in the claims below.

1. A hydraulic system for increasing a speed of a boom of a construction machine, the hydraulic system comprising:
a boom cylinder configured to operate the boom of the construction machine;
a main control valve including a boom control spool that is configured to selectively supply a hydraulic oil from a hydraulic pump to a boom head chamber and a boom rod chamber of the boom cylinder through a boom head hydraulic line and a boom rod hydraulic line, respectively;
a regeneration device connected to the boom head chamber of the boom cylinder through a hydraulic regeneration line and configured to regenerate an energy of the boom cylinder; and
a regeneration valve unit provided at the hydraulic regeneration line and including a flow control valve configured to control a flow rate of a hydraulic oil flowing through the hydraulic regeneration line,
wherein an energy stored in the regeneration device is directly supplied to the boom cylinder through the flow control valve when the boom ascends.

2. The hydraulic system of claim 1, wherein when the boom ascends, the flow control valve of the regeneration valve unit controls a flow rate supplied from the regeneration device to the boom cylinder in proportion to a manipulation amount of a manipulation unit.

3. The hydraulic system of claim 1, wherein the regeneration valve unit further includes an open-close valve provided at a connection line that connects the hydraulic regeneration line and the boom rod chamber, the open-close valve configured to selectively supply part of the hydraulic oil discharged through the hydraulic regeneration line to the boom rod chamber of the boom cylinder.

4. The hydraulic system of claim 3, wherein the open-close valve is closed when the boom ascends.

5. The hydraulic system of claim 1, wherein the regeneration device includes a hydraulic motor connected to the hydraulic regeneration line, and
the hydraulic motor is connected to a drive shaft of an engine and provides a rotational force to the hydraulic pump when the boom descends.

6. The hydraulic system of claim 5, wherein when the boom ascends, the hydraulic motor is controlled so that a torque for engine assistance is not generated.

7. The hydraulic system of claim 6, wherein in the hydraulic motor, a swash plate angle is controlled to be neutral so that a torque for engine assistance is not generated.

8. The hydraulic system of claim 1, wherein the regeneration device includes an accumulator connected to the hydraulic regeneration line, and
a flow rate of a head side of the boom cylinder at a high pressure, which is pressurized when the boom descends, is stored in the accumulator through the hydraulic regeneration line, thereby regenerating an energy of the boom cylinder.

9. The hydraulic system of claim 8, further comprising a first regeneration open-close valve provided between the accumulator and the hydraulic regeneration line,
wherein when the boom descends, the first regeneration open-close valve is opened so that a high-pressure hydraulic oil pressurized by a potential energy of the boom is accumulated, and
when the boom ascends, the first regeneration open-close valve supplies the accumulated hydraulic oil to the hydraulic motor to assist the engine.

10. The hydraulic system of claim 9, further comprising a second regeneration open-close valve provided between downstream of the first regeneration open-close valve and a tank, the second regeneration open-close valve opened to discharge the hydraulic oil accumulated in the accumulator to the tank when the engine is stopped.

11. The hydraulic system of claim 1, further comprising a control unit configured to control the main control valve, the regeneration device, and the regeneration valve unit according to a manipulation signal transmitted by a manipulation unit.

12. The hydraulic system of claim 11, wherein the control unit controls the flow control valve in proportion to a boom speed increase signal manipulated by the manipulation unit, so that when the boom ascends, a hydraulic oil is supplied, in proportion to the boom speed increase signal, directly to the boom cylinder through the flow control valve.
